(19) United States
(12) Patent Application Publication
(10) Pub. No.: US 2013/0118522 A1
(43) Pub. Date: May 16, 2013

(54) METHOD OF CLEANING MULTILAYER COPPER WIRINGS IN ULTRA LARGE SCALE INTEGRATED CIRCUITS AFTER CHEMICAL-MECHANICAL POLISHING

(71) Applicant: HEBEI UNIVERSITY OF TECHNOLOGY, Tianjin (CN)

(72) Inventors: Yuling LIU, Tianjin (CN); Yanyan HUANG, Tianjin (CN); Baimei TAN, Tianjin (CN); Baohong GAO, Tianjin (CN); Qiang ZHOU, Tianjin (CN)

(73) Assignee: HEBEI UNIVERSITY OF TECHNOLOGY, Tianjin (CN)

(21) Appl. No.: 13/738,957

(22) Filed: Jan. 10, 2013

Related U.S. Application Data
(63) Continuation-in-part of application No. PCT/CN2010/080473, filed on Dec. 30, 2010.

(30) Foreign Application Priority Data
Jul. 21, 2010 (CN) 201010232256.7

(51) Int. Cl. B08B 3/12

(52) U.S. Cl. CPC B08B 3/12
USPC 134/1

(57) ABSTRACT

A method of cleaning multilayer copper wirings in ultra large scale integrated circuits after chemical-mechanical polishing, the method including: a) preparing a cleaning solution, the cleaning solution including between 0.1 and 5 wt. % of a nonionic surfactant, between 0.1 and 7 wt. % of a corrosion inhibitor, and between 0.1 and 0.6 wt. % of a chelating agent in deionized water; b) adjusting the pH value of the cleaning solution to between 7 and 8 using triethanolamine; c) during the production of ULSI, after the chemical-mechanical polishing step, washing the multilayer copper wirings with the cleaning solution at a flow rate of between 500 and 5000 mL/min for between 0.5 and 1 min; d) ultrasonic washing in the presence of deionized water under following conditions: 60 Hz frequency of ultrasound, 50° C. temperature, and between 0.5 and 1 min ultrasonic time; and e) drying the multilayer copper wirings.

### CROSS-REFERENCE TO RELATED APPLICATIONS

This application is a continuation-in-part of International Patent Application No. PCT/CN2010/080473 with an international filing date of Dec. 30, 2010, designating the United States, now pending, and further claims priority benefits to Chinese Patent Application No. 201010232256.7 filed Jul. 21, 2010. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a cleaning method, and more particularly to a method of cleaning multilayer copper wirings in ultra large scale integrated circuits (ULSI) after chemical-mechanical polishing (CMP).

2. Descriptions of the Related Art

Chemical-mechanical polishing has been one of the main techniques for flattening during the production of ULSI. Dirt such as grains, organic matters, and metal ions after CMP may cause fatal damages on integrated components. Thus, the removal of dirt after CMP has been a very important area in the development of semi-conductors.

With the increase in the degree of integration of microelectronic components, the number of wiring layers increases, and it is a new trend that copper with low resistance is substituting aluminum for metal interconnections. With the development of CMP, the industry has proposed higher requirements for CMP in order to improve product yields, the most important of which is to assure the cleanness of the polished surface, and to eliminate dirty grains as much as possible. Cleaning process after CMP, especially the cleaning of copper wirings, has been highly required.

In the meanwhile, with the increase in the degree of integration and the decrease in the size of semi-conductor components, semi-conductor techniques have imposed more and more particular requirements on the number and size of adsorbed grains, for example, 200 mm Si wafers and 0.07 μm integrated circuits are required that each has no more than 10 grains with grain size of 20 nm below. The current study objective is to remove nano grains having strong adsorption ability. Conventional commercial cleaning solutions or HF cleaning solutions used to remove dirt easily causes loss of dielectric materials and unnecessary inductive disturbance in copper interconnections. Furthermore, uneven oxidation caused by polishing solution residues is one of the urgent problems to be solved. Therefore, the study of dirty grains removal having no damage on copper wirings after CMP has been an important trend in the development of semi-conductors.

In CMP process for multilayer copper wirings, the contamination of surfaces mainly results from polishing pads, copper grains, SiO₂ grains, and so on. Newly exposed surface of multilayer copper wirings after CMP has high surface energy, and tends to adsorb a layer of matters to achieve a steady state, during which surrounding grains are first physically adsorbed on the surface via van der Waals force which is so weak that grains are easily removable; as the distance becoming closer, energy is quickly released and chemical adsorptions are formed until grains are finally combined together with copper surface, thereby being difficult to be removed by conventional cleaning methods.

Currently, the use of nonionic surfactants in removing surface grains after CMP has been developed. However, polishing solution residues after CMP and adsorbed grains seriously affect the cleanness of copper surface, parts of surface continue reacting with surrounding grains to form corrosion circles. Furthermore, defect points on copper surface have high energy and corrosion rate, and are easy to form corrosion pits, at the same time, copper surface exposed in the air are quickly oxidized, thereby resulting in high resistance, heat release, and electromigration, and finally lowering the reliability of electric elements.

### SUMMARY OF THE INVENTION

In view of the above-described problems, it is one objective of the invention to provide a method of cleaning multilayer copper wirings in ULSI after CMP, which has an easy operation, pollution free, and cleanness.

To achieve the above objective, in accordance with one embodiment of the invention, there is provided a method of cleaning multilayer copper wirings in ULSI after CMP, the method comprising:

a) preparing a cleaning solution comprising:
between 0.1 and 5 wt. % of a nonionic surfactant;
between 0.1 and 7 wt. % of a corrosion inhibitor;
between 0.1 and 0.6 wt. % of a chelating agent; and
deionized water, and the wt. % being based on the total weight of the cleaning solution;

b) adjusting a pH value of the cleaning solution to between 7 and 8 using triethanolamine;

c) washing the multilayer copper wirings after CMP using the cleaning solution at a flow rate of between 500 and 5000 mL/min for between 0.5 and 1 min;

d) ultrasonic washing in the presence of deionized water under following conditions:
ultrasonic frequency: 60 Hz;
temperature: 50° C.; and
time: between 0.5 and 1 min; and

e) drying the multilayer copper wirings.

In a class of this embodiment, the corrosion inhibitor is hexamethylenetetramine and benzotriazole.

Advantages of the invention are summarized below:

Active agent molecules form a compact protecting layer on the surfaces of copper and grains, the protecting layer not only effectively removes dirt on the surface of multilayer copper wirings after CMP, but also effectively lowers the contamination by metal ions, and the irremovable chemical adsorption and bonds of surface grains which are converted to easily removable physical adsorption. Thus, the effective of the invention is obviously superior to that of single nonionic surfactants.

### DETAILED DESCRIPTION OF THE EMBODIMENTS

To further illustrate the invention, experiments detailing a method of cleaning multilayer copper wirings in ULSI after CMP are described below. It should be noted that the following examples are intended to describe and not to limit the invention.

A method of cleaning multilayer copper wirings in ULSI after CMP, the method comprises steps as follows:

a) preparing a cleaning solution, the cleaning solution comprising:
between 0.1 and 5 wt. % of a nonionic surfactant;
between 0.1 and 7 wt. % of a corrosion inhibitor;
between 0.1 and 0.6 wt. % of a chelating agent; and
deionized water, and the wt. % being based on the total weight of the cleaning solution;

b) adjusting a pH value of the cleaning solution to 8 using triethanolamine;

c) washing the multilayer copper wirings shortly after CMP using the cleaning solution at a flow rate of between 500 and 5000 mL/min for between 0.5 and 1 min;

d) ultrasonic washing in the presence of deionized water in a TCQ-250 ultrasonic cleaner under following conditions:
ultrasonic frequency: 60 Hz;
temperature: 50° C.; and
time: between 0.5 and 1 min; and

e) drying after ultrasonic washing.

The corrosion inhibitor is commercially available compounds comprising hexamethylenetetramine and benzotriazole, both of which not only reduce the dirty grains on copper surface, but also effectively prevent copper surface from corrosion and oxidation after CMP, and thus the cleaning effects is achieved.

The surfactant is an FA/0 I surfactant, O_{π}-7 ((C₁₀H₂₁—C₆H₄—O—CH₂CH₂O)₇—H), O_{π}-10 ((C₁₀H₂₁—C₆H₄—O—CH₂CH₂O)₁₀—H), O-20 (C₁₂₋₁₈H₂₅₋₃₇—C₆H₄—O—CH₂CH₂O)₇₀—H), or polyoxyethylene secondary alkyl alcohol ether (JFC), all of which were supplied by Tianjin Jingling Microelectronics Materials Co., Ltd. The surfactant quickly lowers the surface tension of wafers; osmosis converts the surface state into a removable physical adsorption, reduces damaged layers, and improves the evenness of the mass transfer.

The chelating agent is an FA/O II chelating agent: ethylene diamine tetra-acetic acid tetra (tetra-hydroxyethyl ethylene diamine), supplied by Tianjin Jingling Microelectronics Materials Co., Ltd.

The ultrasonic time is only between 0.5 and 1 min, thus the efficiency was improved.

### EXAMPLE 1

Prepare a cleaning solution, the cleaning solution comprising 0.1 wt. % of a nonionic surfactant, 7 wt. % of a corrosion inhibitor, 0.4 wt. % of a chelating agent, and deionized water.

### EXAMPLE 2

Prepare a cleaning solution, the cleaning solution comprising 5 wt. % of a nonionic surfactant, 0.1 wt. % of a corrosion inhibitor, 0.6 wt. % of a chelating agent, and deionized water.

### EXAMPLE 3

Prepare a cleaning solution, the cleaning solution comprising 3 wt. % of a nonionic surfactant, 5 wt. % of a corrosion inhibitor, 0.1 wt. % of a chelating agent, and deionized water.

Cleaning effects of the cleaning solution prepared in above examples using the method of cleaning multilayer copper wirings in ultra large scale integrated circuits after chemical-mechanical polishing are concluded hereinbelow:

1. copper wirings of wafers had no oxidation on the surface;

2. Observations under a microscope at a magnification of 100× showed that copper wirings of wafers had no uneven corrosion, corrosion circles, or pits.

3. Cu²⁺, Fe³⁺, Ni²⁺ and other metal ions on the surfaces of the copper wirings of wafers formed very stable chelats and complexes, the determination by graphite furnace atomic adsorption spectrometry showed that contents of Cu²⁺, Fe³⁺, Ni²⁺ and other metal ions on the surfaces have been reduced to a ppb level below.

Working principles: the nonionic surfactant in the cleaning solution controls adsorption state of grains, in which grains are first adsorbed on copper surface to form a physically-absorbed macromolecule layer. Thus, the adsorbed grains are in a long term sate of physical adsorption which is easily removable. Due to thermal motion of cleaning solution molecules, grains in such a state have micro-displacement on the copper surface, thus broken bonds on copper surface and grains are continuously attracted or undrawn from each other, at this moment, active agent molecules in the nonionic surfactant expand on surfaces of copper and grains to form a compact protecting layer under the effect of osmosis.

Since multipoints adsorptions occur between hydrophilic groups of active agent molecules and the copper surface, during the micro-displacement of grains on the copper surface, non-adsorbed free parts of hydrophilic groups of those free and adsorbed active agent molecules penetrate into contact gaps between the copper surface and grains, attract, and combine with broken bonds of the copper surface and grains at any time, thus, combined bonds between surfaces of grains and coppers are less and less, until grains are finally separated from the copper surface.

The compact protecting layer formed by active agent molecules on the surfaces of the copper and grains avoids secondary adsorptions between grains and the copper surface, and thus the separation of grains from copper surface is accomplished.

At the same time, a corrosion inhibitor (comprising hexamethylenetetramine and benzotriazole) is employed to solve such a problem as continuing uneven oxidation of copper wirings after CMP. The corrosion inhibitor and the copper surface form a surface film comprising a chain of semipermanent polymer complex Cu-BTA. Such a single molecular chemical adsorbed film with a thickness of 5 nm has good adsorption and high thermal stability, and won't be decomposed at 340° C. Thus, BTA has good antioxidant and anticorrosive ability, thereby improving the degree of flattening of copper surface after cleaning.

The pH value of the cleaning solution is between 7 and 8. Experiment results show that, in the presence of a weak alkaline and a nonionic surfactant, osmosis becomes much stronger, which is good for separation of grains.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method of cleaning multilayer copper wirings in ultra large scale integrated circuits after chemical-mechanical polishing, the method comprising:
a) preparing a cleaning solution, the cleaning solution comprising:
between 0.1 and 5 wt. % of a nonionic surfactant;
between 0.1 and 7 wt. % of a corrosion inhibitor;
between 0.1 and 0.6 wt. % of a chelating agent; and
deionized water, and the wt. % being based on the total weight of the cleaning solution;
b) adjusting a pH value of the cleaning solution to between 7 and 8 using triethanolamine;
c) after chemical-mechanical polishing, washing the multilayer copper wirings using the cleaning solution at a flow rate of between 500 and 5000 mL/min for between 0.5 and 1 min;
d) ultrasonic washing in the presence of deionized water under following conditions:
ultrasonic frequency: 60 Hz;
temperature: 50° C.; and
time: between 0.5 and 1 min; and
e) drying the multilayer copper wirings.

2. The method of claim 1, wherein the nonionic surfactant is an FA/O I surfactant, O_{π}-7 ((C₁₀H₂₁—C₆H₄—O—CH₂CH₂O)₇—H), O_{π}-10 ((C₁₀H₂₁—C₆H₄—O—CH₂CH₂O)₁₀—H), O-20 (C₁₂₋₁₈H₂₅₋₃₇—C₆H₄—O—CH₂CH₂O)₇₀—H), or polyoxyethylene secondary alkyl alcohol ether (JFC).

3. The method of claim 1, wherein the corrosion inhibitor is a mixture of hexamethylenetetramine and benzotriazole.

4. The method of claim 1, wherein the chelating agent is [chemical structure]
